(19) United States
(12) Patent Application Publication
(10) Pub. No.: US 2019/0372133 A1
(43) Pub. Date: Dec. 5, 2019

(54) FLOW FIELD PLATE FOR A FUEL CELL, AND FUEL CELL

(71) Applicant: Robert Bosch GmbH, Stuttgart (DE)

(72) Inventor: Helerson Kemmer, Vaihingen (DE)

(21) Appl. No.: 16/472,795

(22) PCT Filed: Dec. 19, 2017
(86) PCT No.: PCT/EP2017/083539

§ 371 Date: Jun. 21, 2019

(30) Foreign Application Priority Data
Dec. 22, 2016 (DE) 10 2016 226 092.8

(51) Int. Cl. H01M 8/0258; H01M 8/1004; H01M 8/0267; H01M 8/0247; H01M 8/0232; H01M 8/0265

(52) U.S. Cl. CPC H01M 8/0258; H01M 8/1004; H01M 8/0265; H01M 8/0247; H01M 8/0232; H01M 8/0267

(57) ABSTRACT

The invention relates to a flow field plate (40) for a fuel cell (2), comprising a first distributing structure (50) having a first distributing region (150) for distributing a fuel to a first electrode (21), a second distributing structure (60) having a second distributing region (160) for distributing an oxidant to a second electrode (22), and a third distributing structure (70) having a third distributing region (170) for conducting a coolant therethrough, which third distributing structure is arranged between the first distributing structure (50) and the second distributing structure (60), wherein the third distributing region (170) is separated from the first distributing region (150) by a fluid-tight first inner separating layer (85) and from the second distributing region (160) by a fluid-tight second inner separating layer (86). Posts (75) extend through the third distributing region (170). Said posts extend from the first inner separating layer (85) to the second inner separating layer (86). The invention also relates to a fuel cell, comprising at least one membrane electrode assembly having a first electrode and a second electrode, which are separated from each other by a membrane, and comprising at least one flow field plate (40) according to the invention.

### BACKGROUND OF THE INVENTION

The invention relates to a bipolar plate for a fuel cell, comprising a first distribution structure having a first distribution region for distribution of a fuel to a first electrode, a second distribution structure having a second distribution region for distribution of an oxidant to a second electrode, and a third distribution structure which is disposed between the first distribution structure and the second distribution structure and has a third distribution region for passage of a coolant, wherein the third distribution region is separated from the first distribution region by a fluid-tight first inner separation layer and is separated from the second distribution region by a fluid-tight second inner separation layer. The invention also relates to a fuel cell comprising at least one bipolar plate of the invention.

A fuel cell is a galvanic cell that converts the chemical reaction energy from a continuously supplied fuel and an oxidant to electrical energy. A fuel cell is thus an electrochemical energy transducer. In known fuel cells, in particular, hydrogen (H2) and oxygen (O2) are converted to water (H2O), electrical energy and heat.

The known fuel cells include proton exchange membrane (PEM) fuel cells. Proton exchange membrane fuel cells have a membrane disposed in the center that is permeable to protons, i.e. to hydrogen ions. The oxidant, especially atmospheric oxygen, is thus spatially separated from the fuel, especially hydrogen.

Proton exchange membrane fuel cells also have an anode and a cathode. The fuel is supplied to the anode of the fuel cell and oxidized catalytically to protons with release of electrons. The protons pass through the membrane to the cathode. The electrons released are led off from the fuel cell and flow via an external circuit to the cathode.

The oxidant is supplied to the cathode of the fuel cell and it reacts by accepting the electrons from the external circuit and protons that pass through the membrane to the cathode to give water. The resultant water is led off from the fuel cell. The overall reaction is:

O₂+4H⁺+4e⁻→2H₂O

There is a voltage between the anode and cathode of the fuel cell. To increase the voltage, it is possible to arrange multiple fuel cells in mechanical succession to give a fuel cell stack and connect them electrically in series.

For homogeneous distribution of the fuel to the anode and for homogeneous distribution of the oxidant to the cathode, gas distributor plates are provided, which are also referred to as bipolar plates. The bipolar plates have, for example, conduit structures for distribution of the fuel and the oxidant to the electrodes. The conduit structures also serve to lead off the water formed in the reaction. The bipolar plates may also have structures for passage of a cooling liquid through the fuel cell to lead off heat.

Also known are bipolar plates having distribution structures for distribution of the fuel to the anode and the distribution of the oxidant to the cathode, which have porous foams. These foams have such porosities that the reaction gases supplied and the water formed in the reaction can flow through.

DE 10 2013 223 776 A1 discloses a bipolar plate for a fuel cell stack. The bipolar plate has distribution structures that have been produced from metallic foam and serve to introduce the reaction gases into the fuel cell stack and to lead off the water formed in the reaction. The bipolar plate also has a distribution structure that has been produced from metallic foam and serves for passage of a cooling fluid.

### SUMMARY OF THE INVENTION

A bipolar plate for a fuel cell is proposed, comprising a first distribution structure having a first distribution region for distribution of a fuel to a first electrode, a second distribution structure having a second distribution region for distribution of an oxidant to a second electrode, and a third distribution structure which is disposed between the first distribution structure and the second distribution structure and has a third distribution region for passage of a coolant. The third distribution region here is separated from the first distribution region by a fluid-tight first inner separation layer and is separated from the second distribution region by a fluid-tight second inner separation layer.

In this context, “fluid-tight” is understood to mean that the inner separation layers are impermeable to the gaseous fuel supplied to the fuel cell, to the gaseous oxidant supplied to the fuel cell, and to the water to be led off from the fuel cell. More particularly, the inner separation layers are also impermeable to the coolant.

According to the invention, the third distribution region is permeated by posts that extend from the first inner separation layer as far as the second inner separation layer. The posts are arranged in the third distribution region in such a way that the coolant can optimally absorb heat from the first distribution structure and from the second distribution structure. The posts may have any desired cross sections, for example circular, elliptical, droplet-shaped, triangular or polygonal. The posts may be arranged symmetrically or else asymmetrically.

Preferably, the bipolar plate is in cuboidal form, and a top face and an opposite bottom face of the bipolar plate are in fluid-permeable form. The first distribution region here adjoins the bottom face, and the second distribution region adjoins the top face. The fuel can get to the first electrode through the fluid-permeable bottom face. The oxidant can get to the second electrode through the fluid-permeable top face.

In an advantageous configuration of the invention, the first distribution structure and the second distribution structure are each formed by a porous foam, where the fluid-tight first inner separation layer is in one-piece form together with the porous foam of the first distribution structure, and the fluid-tight second inner separation layer is in one-piece form together with the porous foam of the second distribution structure.

Such a foam is producible, for example, by a melt metallurgy production process. This involves first creating a porous shaped body as spacer, made, for example, of polyurethane or similar material. The spacer is formed so as to give rise to a space with open porosity in its interior, and some sides are entirely free of spacer material. The interior space with open porosity is also divided by two clear spaces. The end region is also formed by partially clear spaces, such that the necessary dividing walls for the sealing of the media can form subsequently. The shaped body is then encapsulated with a liquid encapsulating compound. The liquid encapsulating compound is, for example, a metal melt. The encapsulating compound penetrates here into the space with open porosity and into the clear end spaces, interior spaces and lateral spaces of the shaped body and, after solidification, forms the foam with open porosity and the fluid-tight separation layers that have a thickness of 10 to 100 μm. The spacer material is then removed by purging or burning it off.

If, as a result of the production process for the foam, all areas are closed by a fluid-tight separation layer, the separation layer is subsequently removed at the bottom face and at the top face.

In an advantageous configuration of the invention, the porous foam of the first distribution structure and/or the second distribution structure is in inhomogeneous form and has varying porosity. Porosity is understood here to mean the ratio of the void volume to the total volume of the porous foam. The more voids and the larger the voids present in the foam, the greater the porosity.

Preferably, a porosity of the porous foam of the first distribution structure in the vicinity of the bottom face is lower than in the vicinity of the first inner separation layer. A porosity of the porous foam of the second distribution structure in the vicinity of the top face is likewise less than in the vicinity of the second inner separation layer.

Advantageously, two opposite lateral faces of the bipolar plate are each formed entirely by a fluid-tight outer separation layer which is in one-piece form together with the porous foam. Likewise advantageously, two opposite end faces of the bipolar plate are each formed entirely by a fluid-tight outer separation layer which is in one-piece form together with the porous foam.

Alternatively, it is conceivable that fluid-permeable regions through which the fuel gets to the first electrode and the oxidant to the second electrode are disposed at least partly at the lateral faces and at the end faces.

Preferably, the porous foam of the first distribution structure and the porous foam of the second distribution structure have been manufactured from a metallic material. Thus, the distribution structures are electrically conductive.

In advantageous development of the invention, the first inner separation layer and/or the second inner separation layer is in corrugated form. The first inner separation layer and/or the second inner separation layer is thus not in flat or even form, but has varying distances from the top face and from the bottom face of the bipolar plate.

The posts in the third distribution region may have been manufactured, for example, from a porous material. More particularly, the posts may have been formed from a porous foam similarly to the first distribution structure and the second distribution structure.

The posts in the third distribution region may alternatively have been manufactured from a solid material and hence have zero porosity.

Also proposed is a fuel cell comprising at least one membrane electrode unit having a first electrode and a second electrode which are separated from one another by a membrane, and at least one bipolar plate of the invention. More particularly, the fuel cell is constructed in such a way that the membrane electrode unit is adjoined by a bipolar plate on either side.

In the bipolar plate of the invention, optimal release of heat to the coolant in the third distribution structure is assured. The inventive configuration of the third distribution region in the third distribution structure results in a minimal pressure drop of the coolant as it flows through the third distribution region. This results in a drop in the demands of a coolant pump, especially on the power thereof, that pumps coolant through the bipolar plate. As a result of the inhomogeneously formed distribution structures for distribution of the fuel and of the oxidant, these distribution structures can also assume the function of a gas diffusion layer. Separate gas diffusion layers are thus not required. The bipolar plate also has excellent electrical and thermal conductivity. By means of the bipolar plate of the invention, the distribution of the fuel and of the oxidant and the removal of the water formed as a result of the reaction are optimal. Moreover, the costs for the manufacture of the bipolar plate and of a fuel cell stack are comparatively low.

### BRIEF DESCRIPTION OF THE DRAWINGS

Embodiments of the invention are elucidated in detail by the drawings and description that follows.

The figures show:

FIG. 1 a schematic diagram of a fuel cell stack with multiple fuel cells,

FIG. 2 a section view of a bipolar plate of the fuel cell stack from FIG. 1,

FIG. 3 a section through the bipolar plate from FIG. 2,

FIG. 4 a scaled-up view of a section of a first distribution structure,

FIG. 5 a scaled-up view of a section of a second distribution structure and

FIG. 6 a section view of a bipolar plate of the fuel cell stack from FIG. 1 in a modified embodiment.

### DETAILED DESCRIPTION

In the description of the embodiments of the invention which follows, identical or similar elements are identified by the same reference numerals, dispensing with repeated description of these elements in individual cases. The figures represent the subject matter of the invention merely in schematic form.

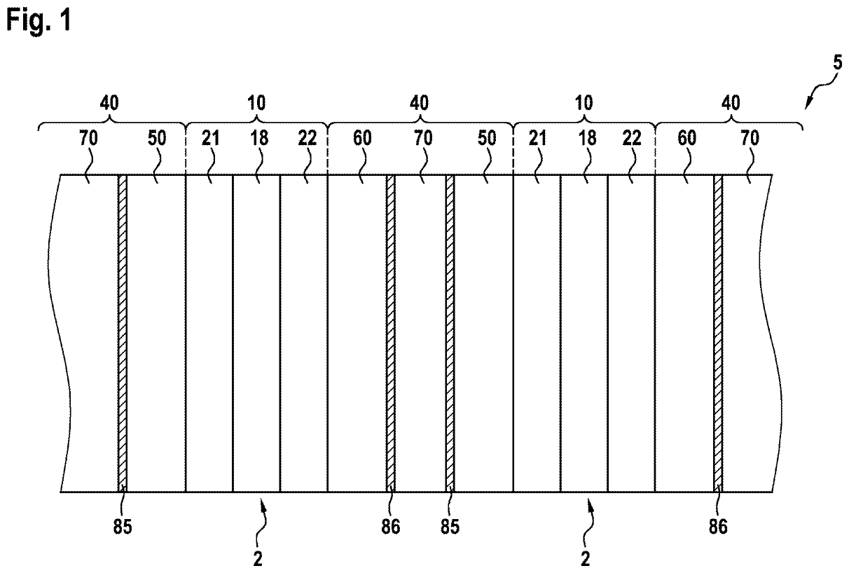

FIG. 1 shows a schematic diagram of a fuel cell stack 5 with multiple fuel cells 2. Each fuel cell 2 has a membrane electrode unit 10 comprising a first electrode 21, a second electrode 22 and a membrane 18. The two electrodes 21, 22 are disposed on mutually opposite sides of the membrane 18 and are thus separated from one another by the membrane 18. The first electrode 21 is also referred to hereinafter as anode 21, and the second electrode 22 is also referred to hereinafter as cathode 22. The membrane 18 takes the form of a polymer electrolyte membrane. The membrane 18 is permeable to hydrogen ions, i.e. W ions.

Each fuel cell 2 also has two bipolar plates 40 that adjoin the membrane electrode unit 10 on either side. In the arrangement shown here of multiple fuel cells 2 in the fuel cell stack 5, each of the bipolar plates 40 may be regarded as belonging to two fuel cells 2 in a mutually adjacent arrangement.

The bipolar plates 40 each comprise a first distribution structure 50 for distribution of a fuel, which faces the anode 21. The bipolar plates 40 each also comprise a second distribution structure 60 for distribution of the oxidant, which faces the cathode 22. The second distribution structure 60 simultaneously serves to lead off water formed in a reaction in the fuel cell 2.

The bipolar plates 40 also comprise a first distribution structure 70 disposed between the first distribution structure 50 and the second distribution structure 60. The third distribution structure 70 serves for passage of a coolant through the bipolar plate 40 and hence for cooling of the fuel cells 2 and the fuel cell stack 5.

The first distribution structure 50 and the third distribution structure 70 are separated from one another by a first inner separation layer 85. The second distribution structure 60 and the third distribution structure 70 are separated from one another by a second inner separation layer 86. The inner separation layers 85, 86 of the bipolar plates 40 are in fluid-tight form.

In the operation of the fuel cell 2, fuel is guided via the first distribution structure 50 to the anode 21. Oxidant is likewise guided via the second distribution structure 60 to the cathode 22. The fuel, hydrogen in the present case, is oxidized catalytically at the anode 21 to protons with release of electrons. The protons pass through the membrane 18 to the cathode 22. The electrons released flow through the distribution structures 50, 70, 60 to the cathode 22 of the adjacent fuel cell 2, or from the anode of the fuel cell 2 present at one edge via an external circuit to the cathode 22 of the fuel cell 2 present at the other edge. The oxidant, atmospheric oxygen in the present case, reacts by accepting the electrons thus conducted and the protons that have arrived at the cathode 22 through the membrane 18 to give water.

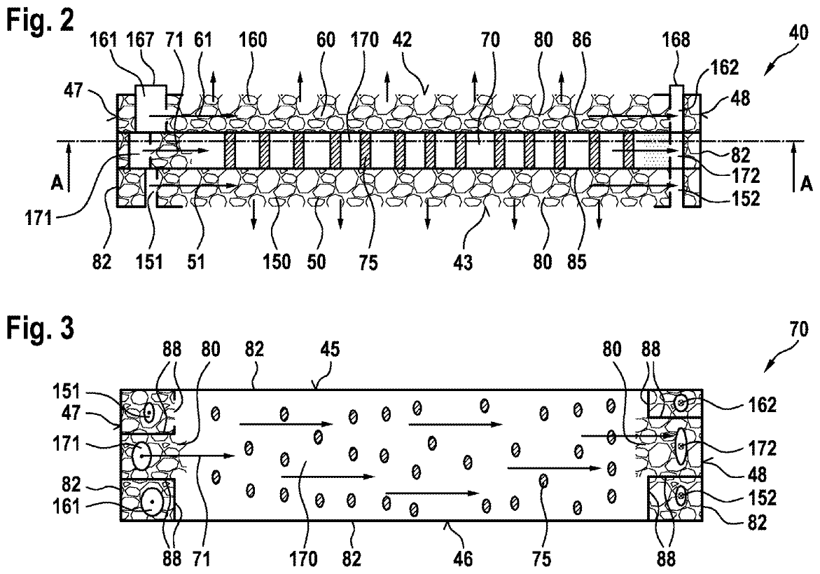

FIG. 2 shows a section view of a bipolar plate 40 of the fuel cell stack 5 from FIG. 1. The bipolar plate 40 is penetrated by a first feed conduit 151, a second feed conduit 161 and a third feed conduit 171. The bipolar plate 40 is also penetrated by a first drain conduit 152, a second drain conduit 162 and a third drain conduit 172. In the view shown, the first distribution structure 50 is cut by the first feed conduit 151 and the first drain conduit 152, the second distribution structure 60 is cut by the second feed conduit 161 and the second feed conduit 162, and the third distribution structure 70 is cut by the third feed conduit 171 and the third drain conduit 172.

The first distribution structure 50 is formed by a porous foam 80 that has been manufactured from a metallic material. The first distribution structure 50 has a central first distribution region 150 for distribution of the fuel to the anode 21. The first distribution region 150 is connected to the first feed conduit 151 and the first drain conduit 152. The fluid-tight first inner separation layer 85 is in one-piece form together with the porous foam 80 of the first distribution structure 50.

The second distribution structure 60 is formed by a porous foam 80 that has been manufactured from a metallic material. The second distribution structure 60 has a central second distribution region 164 for distribution of the oxidant to the cathode 22. The second distribution region 160 is connected to the second feed conduit 161 and the second drain conduit 162. The fluid-tight second inner separation layer 86 is in one-piece form together with the porous foam 80 of the second distribution structure 60.

The third distribution structure 70 has a central third distribution region 170 for passage of the coolant. The third distribution region 170 is connected to the third feed conduit 171 and the third drain conduit 172. The third distribution region 170 is essentially in hollow form. The third distribution region 170 is permeated by multiple posts 75 that extend from the first inner separation layer 85 as far as the second inner separation layer 86. The posts 75 in the present case are manufactured from a solid material, especially a metal. The posts may also have been manufactured from a porous material, for example a foam 80.

The bipolar plate 40 is in cuboidal form and has a top face 42, an opposite bottom face 43, a first end face 47, an opposite second end face 48, a first lateral face 45 (invisible here) and an opposite second lateral face 46 (invisible here). The top face 42 and the bottom face 43 run parallel to one another and in the present case also parallel to the inner separation layers 85, 86. The top face 42 and the bottom face 43 run at right angles to the end faces 47, 48 and at right angles to the lateral faces 45, 46. The end faces 47, 48 run at right angles to the lateral faces 45, 46.

The first distribution region 150 adjoins the bottom face 43, which is in fluid-permeable form. The first feed conduit 151 serves to introduce the fuel. The first drain conduit 152 serves to discharge fuel which is not required. The fuel flows in a first flow direction 51 through the first feed conduit 51 into the first distribution region 150. A portion of the fuel flows from there through the bottom face 43 to the anode 21 (not shown here). A further portion of the fuel flows out of the first distribution structure 50 through the first drain conduit 152.

The second distribution region 160 adjoins the top face 42, which is in fluid-permeable form. The second feed conduit 161 serves to introduce the oxidant. The second drain conduit 162 serves to discharge oxidant which is not required. The oxidant flows in a second flow direction 61 through the second feed conduit 161 into the second distribution region 160. A portion of the oxidant flows from there through the top face 42 to the cathode 22 (not shown here). A further portion of the oxidant flows out of the second distribution structure 60 through the second drain conduit 162.

The third feed conduit 171 serves to introduce the coolant. The third drain conduit 172 serves to discharge the coolant. The coolant flows in a third flow direction 71 through the third feed conduit 171 into the third distribution region 170 and out of the third distribution structure 70 through the first drain conduit 172.

The bipolar plate 40 has assembly nipples 167, 168, which project from the second distribution structure 60 and in the present case are in hollow cylindrical form. A first assembly nipple projects from the first feed conduit 151, a second assembly nipple projects from the first drain conduit 152, a third assembly nipple 167 projects from the second feed conduit 161, a fourth assembly nipple 168 projects from the second drain conduit 162, a fifth assembly nipple projects from the third feed conduit 171, and a sixth assembly nipple projects from the third drain conduit 172. In the view shown here, only the third assembly nipple 167 and the fourth assembly nipple 168 are visible. In the assembled fuel cell stack 5, the assembly nipples 167, 168 project into the feed conduits 151, 161, 171 and into the drain conduits 152, 162, 172 of an adjacent bipolar plate 40.

FIG. 3 shows a section through the bipolar plate 40, especially through the third distribution structure 70, along the section line A-A from FIG. 2. The third distribution structure 70 has regions formed from a porous foam 80 in the vicinity of the feed conduits 151, 161, 171 and the drain conduits 152, 162, 172.

The feed conduits 151, 161, 171 are separated from one another by fluid-tight dividing walls 88 that are in one-piece form together with the porous foam 80. The drain conduits 152, 162, 172 are also separated from one another by fluid-tight dividing walls 88, which are in one-piece form together with the porous foam 80. The lateral faces 45, 46 and the end faces 47, 48 are each formed entirely by a fluid-tight outer separation layer 82. The outer separation layers 82 of the lateral faces 45, 46 and of the end faces 47, 48 are each in one-piece form here together with the porous foam 80. The inner separation layers 85, 86 merge into the outer separation layers 82. The dividing walls 88 merge into the inner separation layers 85, 86 and into the outer separation layers 82.

The first drain conduit 152 is arranged in such a way that optimal flow of the fuel is possible, based on the first feed conduit 151. For example, the first feed conduit 151 and the first drain conduit 152 are arranged at diagonally opposite corners of the first distribution structure 50. The second feed conduit 162 is arranged such that optimal flow of the oxidant is possible, based on the second feed conduit 161. For example, the second feed conduit 161 and the second drain conduit 162 are arranged at diagonally opposite corners of the second distribution structure 60.

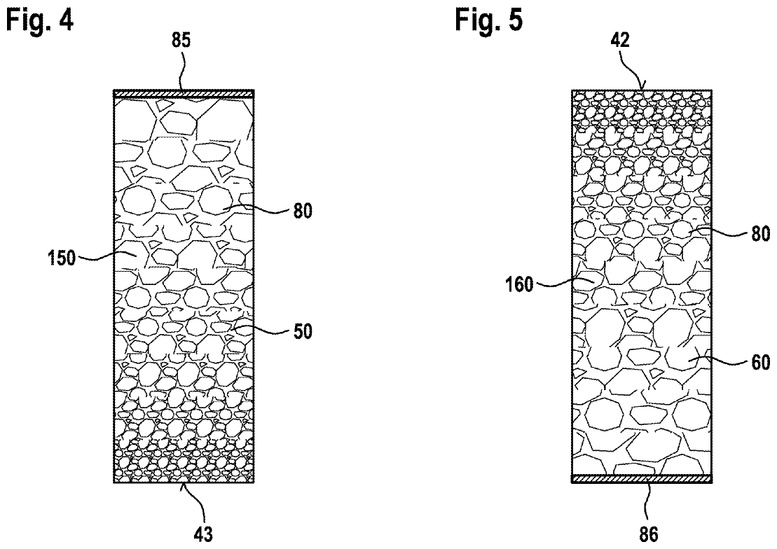

FIG. 4 shows a scaled-up view of a section of the first distribution structure 50. The porous foam 80 of the first distribution structure 50 is in inhomogeneous form and has varying porosity. The porosity of the porous foam 80 in the vicinity of the bottom face 43 is lower than in the vicinity of the first inner separation layer 85.

FIG. 5 shows a scaled-up view of a section of the second distribution structure 60. The porous foam 80 of the second distribution structure 60 is in inhomogeneous form and has varying porosity. The porosity of the porous foam 80 of the second distribution structure 60 in the vicinity of the top face 42 is lower than in the vicinity of the second inner separation layer 86.

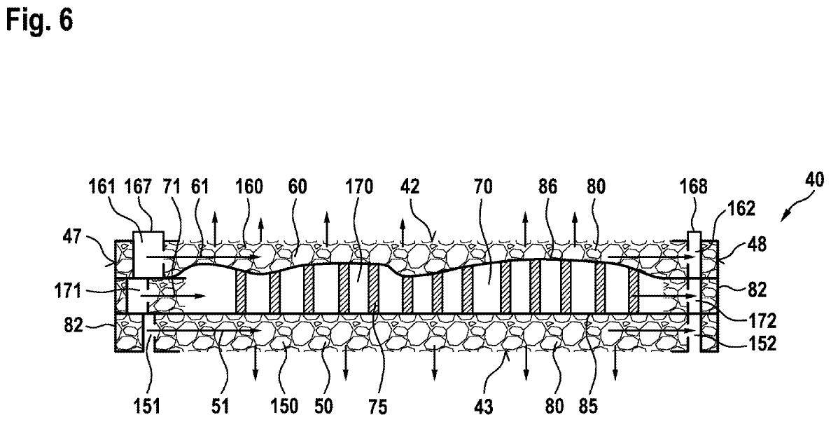

FIG. 6 shows a section view of a bipolar plate 40 of the fuel cell stack from FIG. 1 in a modified embodiment. The bipolar plate 40 in the modified embodiment shown here corresponds largely to the bipolar plate 40 shown in FIG. 2. Only the differences are addressed hereinafter.

The second inner separation layer 86 here is not in flat or even form but in corrugated form. The second inner separation layer 86 thus has, along the third distribution region 170, varying distances from the top face 42 and from the bottom face 43 of the bipolar plate 40. The first inner separation layer 85 is in flat form in the present case, but could likewise be in corrugated form.

By appropriate configuration of the inner separation layers 85, 86, it is possible to influence the flow of the fuel in the first distribution region 150 and of the oxidant in the second distribution region 160.

The invention is not limited to the working examples shown here and the aspects emphasized therein. Instead, a multitude of modifications that are within the routine activity of the person skilled in the art is possible within the scope specified by the claims.

1. A bipolar plate (40) for a fuel cell (2), comprising
a first distribution structure (50) having a first distribution region (150) for distribution of a fuel to a first electrode (21),
a second distribution structure (60) having a second distribution region (160) for distribution of an oxidant to a second electrode (22), and
a third distribution structure (70) which is disposed between the first distribution structure (50) and the second solution structure (60) and has a third distribution region (170) for passage of a coolant,
wherein the third distribution region (170) is separated from the first distribution region (150) by a fluid-tight first inner separation layer (85) and is separated from the second distribution region (160) by a fluid-tight second inner separation layer (86), and
wherein the third distribution region (170) is permeated by posts (75) which extend from the first inner separation layer (85) as far as the second inner separation layer (86).

2. The bipolar plate (40) as claimed in claim 1, wherein the bipolar plate (40) is in cuboidal form, a top face (42) and an opposite bottom face (43) of the bipolar plate (40) are in fluid-permeable form, the first distribution region (150) adjoins the bottom face (43), and the second distribution region (160) adjoins the top face (42).

3. The bipolar plate (40) as claimed in claim 2, characterized in that
the first distribution structure (50) and the second distribution structure (60) are each formed by a porous foam (80),
wherein the fluid-tight first inner separation layer (85) is in one-piece form together with the porous foam (80) of the first distribution structure (50), and the fluid-tight second inner separation layer (86) is in one-piece form together with the porous foam (80) of the second distribution structure (60).

4. The bipolar plate (40) as claimed in claim 3, characterized in that
the porous foam (80) of the first distribution structure (50) and/or of the second distribution structure (60) is in inhomogeneous form and has a varying porosity.

5. The bipolar plate (40) as claimed in claim 3, wherein a porosity of the porous foam (80) of the first distribution structure (50) in the vicinity of the bottom face (43) is less than in the vicinity of the first inner separation layer (85), and/or wherein a porosity of the porous foam (80) of the second distribution structure (60) in the vicinity of the top face (42) is less than in the vicinity of the second inner separation layer (86).

6. The bipolar plate (40) as claimed in claim 3, wherein two mutually opposite lateral faces (45, 46) of the bipolar plate (40) are each formed entirely by a fluid-tight outer separation layer (82) which is in one-piece form together with the porous foam (80), and/or wherein two mutually opposite end faces (47, 48) of the bipolar plate (40) are each formed entirely by a fluid-tight outer separation layer (82) which is in one-piece form together with the porous foam (82).

7. The bipolar plate (40) as claimed in claim 3, characterized in that
the porous foam (80) of the first distribution structure (50) and/or the porous foam (80) of the second distribution structure (60) is formed from a metallic material.

8. The bipolar plate (40) as claimed in claim 1, characterized in that
the first inner separation layer (85) and/or the second inner separation layer (86) is in corrugated form.

9. The bipolar plate (40) as claimed in claim 1, characterized in that
the posts (75) are made of a porous material.

10. The bipolar plate (40) as claimed in claim 1, characterized in that
the posts (75) are made of a solid material.

11. A fuel cell (2) comprising
at least one membrane electrode unit (10) having a first electrode (21) and a second electrode (22) which are separated from one another by a membrane (18), and
at least one bipolar plate (40) as claimed in claim 1.
